(19) United States
(12) Patent Application Publication
(10) Pub. No.: US 2004/0225526 A1
(43) Pub. Date: Nov. 11, 2004

(54) Method for phone solicitations

(76) Inventor: Mark B. Gould, Newport Beach, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/841,879

(22) Filed: May 6, 2004

Related U.S. Application Data
(63) Continuation-in-part of application No. 10/431,851, filed on May 7, 2003.

(51) Int. Cl. G06F 17/60

(52) U.S. Cl. 705/1

(57) ABSTRACT

A solicitation method comprises the steps of: providing a WAN accessible client prospects database, wherein the database includes an encrypted lead telephone number; installing a solicitation software program into a user computer system wherein the computer system has an automatic phone dialup feature and a WAN accessing feature; interconnecting the computer system with the client prospects database through the WAN over a phone network; and, for each of the client telephone numbers, presenting a client identity on a monitor of the computer system; executing automatic dialup of the respective client telephone number without disclosing the client telephone number to the user; communicating a connection result, as good or bad, to the database; and compiling a service billing based on only the good connections.

### RELATED APPLICATIONS

This application is a Continuation In Part Application of a prior filed application having Ser. No. 10/431,851 and filing date of May 7, 2003 and entitled: Method for phone solicitations.

### BACKGROUND OF THE INVENTION

### INCORPORATION BY REFERENCE

Applicant(s) hereby incorporate herein by reference, any and all U.S. patents, U.S. patent applications, and other documents and printed matter cited or referred to in this application.

1. Field of the Invention:

This invention relates generally to phone sales methods and more particularly to such a method wherein the sales representative is not made aware of the phone number contacted until the contact is made and wherein the sales representative is billed only when the person contacted and the phone number are found to correspond.

2. Description of Related Art

The following art defines the present state of this field:

Cameron et al., U.S. Pat. No. 5,737,726 describes a customer contact management system. The system can be customized in order to provide custom contact types and sub-types for the types of contacts relating to individual customers, groups of customers, and business entities. User preferences may be defined to further customize the system to provide the most convenient and time efficient searching, entry, and response actions. Prior contacts can be searched and located by generating filter criteria through the order-independent selection of contact types, contact sub-types, customer identification, and customer contact dates. Records detailing the nature of the customer contact can be stored, whether the contact is user-initiated, system-initiated, or customer-initiated. Internal messages and scripted messages are provided to assist the user of the system in conducting customer service activities. The number and frequency of the internal and scripted messages can be altered according to the experience level of the user.

Melchione et al., U.S. Pat. No. 5,966,695 describes an electronic sales and service support system and method for identifying sales targets using a centralized database to improve marketing success. The system includes a central database that receives comprehensive information from a variety of internal and external feeds, and standardizes and households the information in a three-level hierarchy (households, customers, and accounts) for use by a financial institution. The comprehensive information stored on the central database is accessed through micromarketing workstations to generate lists of sales leads for marketing campaigns. A database engine is provided for generating logical access paths for accessing data on the central database to increase speed and efficiency of the central database. The system distributes sales leads electronically to branch networks, where the sales leads are used to target customers for marketing campaigns. The central database is accessed by workstations of a central customer information system for profiling customers, enhancing customer relationships with the financial institution, and electronically tracking sales performance during marketing campaigns.

Miloslavsky, U.S. Pat. No. 6,130,933 describes a telephony call center system comprising an Internet connection adapted for receiving data from a WEB server, the data originating from the computer platform of a person browsing the Internet, including data identifying the browsing person, such as a telephone number, and indicating to the WEB server a desire of the browsing person to communicate with an agent at the call center. The communication desired may be (a) a request for an agent at the call center to receive a telephone call from a browsing person, or (b) a request for a call to be placed to the browsing person from the call center. In both (a) and (b) the practical result is a telephone conference between the browsing person and an agent at the call center. In the first instance (a), in response to the data from the WEB server to the call center, the call center provides to the WEB server, for transfer to the browsing person via the Internet, a telephone number of a routing point at the call center. The call center selects an agent and initiates a watch for an arriving call from the browsing person. On arrival of the call, it is switched to the selected agent. In the other instance (b), in response to the data, the call center enters the browsing person's telephone number to a dialer and, when the dialer completes a call to the browsing person, switches the call to a selected agent.

Hammons et al., U.S. Pat. No. 6,477,509 describes a method and system for communication and trade on a network, in which information is directed at the computer screen of a consumer by merchants of goods, services, or information. A lending partner would provide the initial capital to offer the consumer an incentive for signing up for the system, and for supplying pertinent information about herself. A management system would integrate the merchant information with consumer information, to send a targeted stream of information to the user. Purchases could be made from the system, whether connected to the network or not. Background data transfer or auto-refreshing of data would be options for the system. The lending partner would be repaid for the consumer's incentive from revenues paid into the management system related to each individual consumer transaction.

Johnson, Jr. et al., U.S. Pat. No. 6,480,474 describes A digital communication network such as the Internet that is used to establish and control the telephone connections between two conferees with the telephone network being the means of exchanging verbal information. Each of the two conferees has a computer connected to the digital network, and each has an independent telephone instrument connected to the public switched telephone network. One of the conferees utilizes his computer containing appropriate software to initiate the call to the other conferee. The initiating conferee sends digital control information to a switch interface controlling a telephone switch as a gateway to the telephone network using SS7 control signals which implements the telephone connection between the conferees. The switch also provides telephone status information transmitted back over the digital network, and the status information is displayed on the computer monitors of the conferees.

Cook, U.S. 2002/0059095 describes a customer lead management system that relates to a system and method for collecting and organizing customer-marketing data, which is then made available to business representatives to assess. Specifically, using a computer network and, data on a potential customer's Budget, Authority, Needs, Timeline, and other related customer lead data is collected. After this data is collected the customer lead management system stores the customer lead data and ranks the viability of the customer based on the interest level of the customer lead and other variable criteria. The resulting customer lead profile is then stored in a database. The customer lead data is then capable of being accessed via a computer network by various companies that have goods/services that satisfy the needs and requirements of the customer lead. A company representative can be automatically notified when a customer lead profile has been updated.

Benson et al., U.S. 2002/0067820 describes a method of managing a call system for a computer telephony integrated call center system, said call center system comprising two or more customer call lists for at least one business telephony application, said method comprising: retrieving customer records for the same customer from a number of call lists; and combining said customer records to form a combined call list for said customer. A plurality of combined call lists for a plurality of customers is stored in a combined call list database. Whenever a call is outbound to a customer or inbound to a customer the combined list for that customer is displayed so that calls to that customer can be managed.

Chester, U.S. 2002/0095502 describes a system and method for establishing a secure virtual trading zone for customers of a service provider, in which bandwidth and applications are provided dynamically and in which the communication path is controlled. The service provider performs the following steps: receiving a request from a customer to establish communication with another customer; confirming the identity of each customer; transmitting to each customer executable code enabling encrypted communication therewith; obtaining from each customer information regarding the customer's computing environment; preparing a set of applications for use by each customer, in accordance with the customer information and the customer's request; transmitting the set of applications as executable code to each customer; establishing a communication path to each customer; and specifying the communication path to the customers, thereby permitting the customers to communicate over the path using those applications.

Bernstein, U.S. 2002/0107730 describes a method and apparatus for identifying potential customers for delivery of promotional materials. The method includes the steps of forming a customer profile by a vendor for targeting delivery of the promotional materials to potential customers, identifying customers which match the customer profile within a database of a third party and forwarding promotional materials to the identified customers.

The prior art teaches a method for identifying customers for delivery of promotional materials; a business to business system for intranet and Internet applications; a call management system using combined calling lists; a method for generating, capturing, and managing customer lead information over a computer network; a telephone call-back system controlled by an online data network in real time; an Internet marketing method and system; a method for coordinating telephone and data communications; a sales and marketing support system using a graphical query prospect database; and a customer contact management system; but does not teach the present method of delivery of a sales lead database with confidential phone numbers, contacting the entities and after decision making, receiving billing based on good sales leads only. The present invention fulfills these needs and provides further related advantages as described in the following summary.

### SUMMARY OF THE INVENTION

The present invention teaches certain benefits in construction and use which give rise to the objectives described below.

It is well known, in commerce, that prospective sales prospects information (sales leads) is valuable and is therefore made commercially available by data sources to businesses who use such information in their sales operations. Sales lead information usually consists of the names, addresses and telephone numbers of large numbers of individuals or firms that may have expressed or shown an interest in certain products or services in the past and are therefore potential prospects for new business. The sales lead information may also qualify the leads in one or more ways as to quality such as high, medium or low probability, etc. Lists of such leads are compiled and made commercially available in the marketplace, and are generally sold for a price per lead. However, such lists are generally known to be less than accurate and, at least in part, may not result in successful sales activity. The following description of the present invention presents a method to deal with the problem, i.e., how to discount for those sales efforts that are not successful due to list quality, while still billing for those efforts which are not successful due to no fault of list quality. Further, the present invention method teaches that the user is invoiced only for those leads that are actively contacted and solicited, while portions of a lead list that are not contacted, or for which no attempt to contact, are not invoiced. Plainly, then, the user is invoiced and only pays for those leads actually contacted where the lead's phone number was accurate.

In this invention description sales prospects or prospective clients are provided by a sales lead service which shall be referred to as the “service.” The prospective clients are provided to companies or organizations, referred to herein as “users,” that are interested in performing sales solicitation activities and, therefore, are in need of sales lead lists and are willing to purchase same. The individuals or companies that make up the sales lead list shall be referred to as sales leads, or “leads” for short. Leads are listed in an information database provided by the service and are used by the users to contact the leads for sales solicitation or similar purposes.

In one aspect of a preferred embodiment of the present invention a solicitation method comprises the steps of: providing a WAN accessible lead database, wherein the database comprises lead telephone numbers and includes the steps of installing a solicitation software program into a user's computer system wherein the user's computer system has an automatic phone dialup feature and a WAN accessing feature. The method further includes the steps of interconnecting the user's computer system with the lead database through the WAN over a public telephone system or other wired or wireless communication interconnection system; and, for each of the lead telephone numbers, at the user computer system, in turn, presenting a lead identity on a display of the user's computer system; executing automatic dialup of each lead's telephone number without disclosing the telephone number to the user; logging a connection result, as good or bad, to the database; and compiling a service invoice based on only good connection results, i.e., where the telephone number called corresponds to the person being contacted (lead) and connection was made.

A primary objective of the present invention is to provide an apparatus and method of use of such apparatus that provides advantages not taught by the prior art.

Another objective is to provide such an invention capable of automatically dialing leads without disclosing their telephone number to a user.

A further objective is to provide such an invention capable of billing for only satisfactory connections made to the leads by the user.

A still further objective is to provide such an invention capable of providing blind dialing of leads, that is, without knowing the lead's phone number, and logging those connections that result in a good connection; then enabling the user to log detailed information about the lead, including telephone number, and finally setting a reminder for callback to lead's that were dialed without satisfactory connection, i.e., neutral results.

A yet further objective is to provide such an invention capable of selecting leads at random from a lead list provided to a user.

A yet further objective is to provide status of a solicitation phone call as a means of establishing the quality of the lead.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a logic diagram of the preferred embodiment of the invention method; and

FIGS. 2-7 are pictures of computer monitor screens depicting the invention method.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

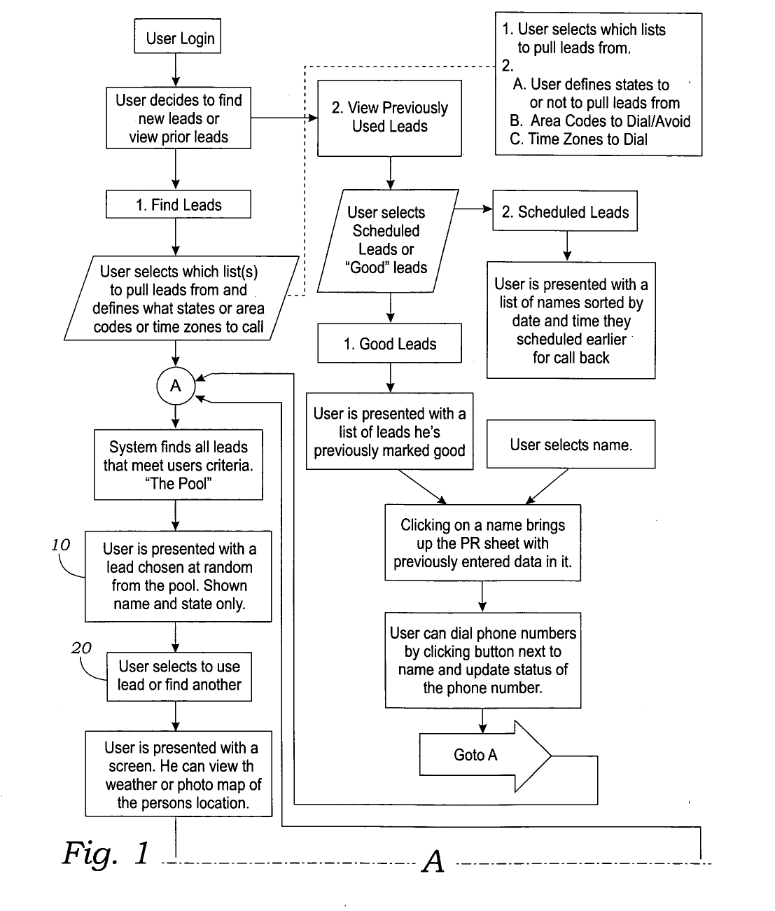

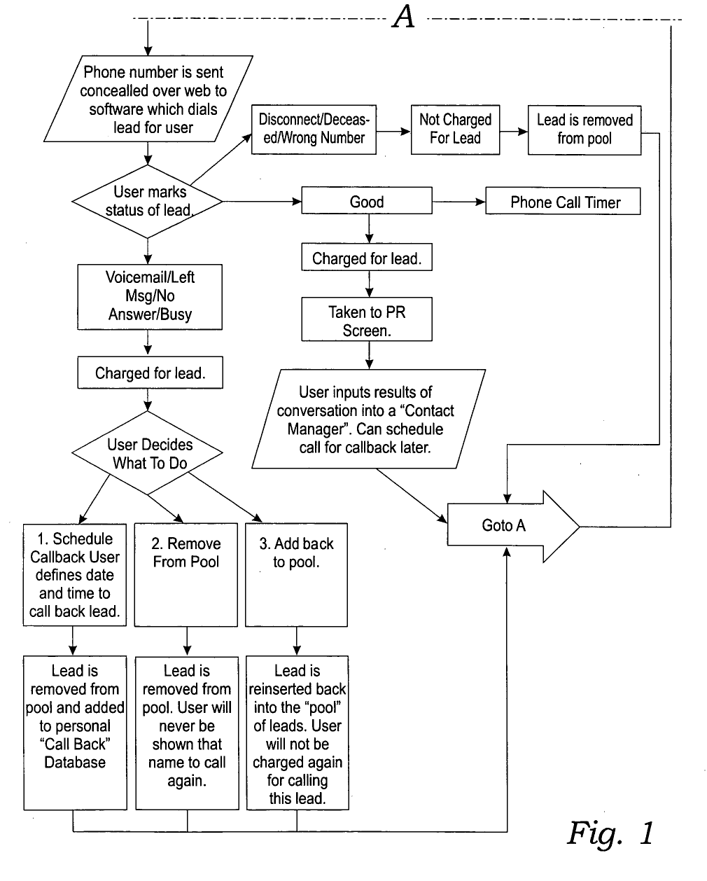

One aspect of a preferred embodiment of the present invention, as shown in FIG. 1, is a phone solicitation method using a wide area network, or WAN, such as the Internet, as a means for access to a lead database provided by a service. The method, is easily formed into a data processing program set of instructions by those of skill in the software programming art. No part of such an instruction set would be outside the skill of a routine software engineer. However, the steps taken in any such program set are highly novel producing desirable results unknown in the industry or art. The WAN is preferably the Internet but may be any other network for connecting a user with a provided database of leads. Each lead in the database includes a telephone number and lead identity. The method includes the steps of installing the software program which operates in accordance with FIG. 1, into one or more local user computer systems. Users are typically telephone solicitation sales organizations. Each computer system has an automatic phone dialup feature, such as a modem operated by any commercial operating software and this enablement is very well known in the art for phone service in a public or private telephone network. The user also has a WAN accessing feature such as Internet Explorer®, a product of Microsoft Corporation, or any of the equivalent products well known in the art so as to interconnect the user with the Internet. Therefore, the present invention enables users to contact selected leads by an active voice dialup method. The service may involve hundreds of users and the users, each, may utilize many hundreds or thousands of leads.

In operation, at the request of a user, a large number of leads, in a database, is delivered to the user's computer system via the WAN. This does not create a billable event. At his/her request, the user is presented with the identity of a single lead, preferably name and location, on a display of the user's computer system, but is not able to see the lead's telephone number, although the telephone number is, in fact, delivered in the database and it is used in the method of the present invention by the user. Automatic dialup of the lead's telephone number is accomplished, as is well known in the art, and, again, without disclosing the number to the user. At this time, the user may make voice contact with the lead and this may result in a benefit to the user, such as acceptance by the lead of a sales contract for an item or service the customer is soliciting. It may also result in a negative or a neutral result as is well known in the sales industry. If the phone number dialed is busy, the lead can be selected, by the user, for later contact. If the phone number is inactive or a “wrong number,” the user is able to identify this and will not be invoiced for the lead.

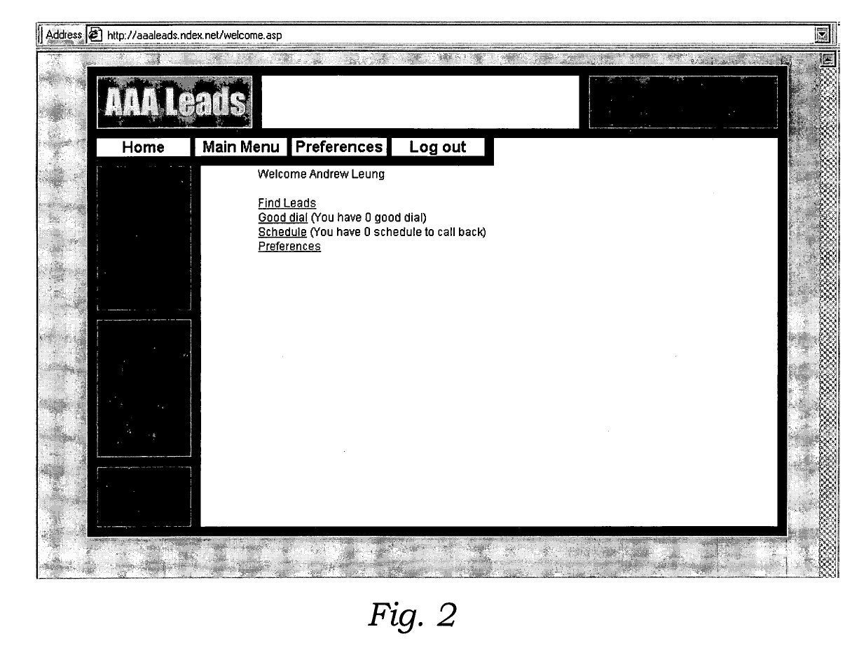

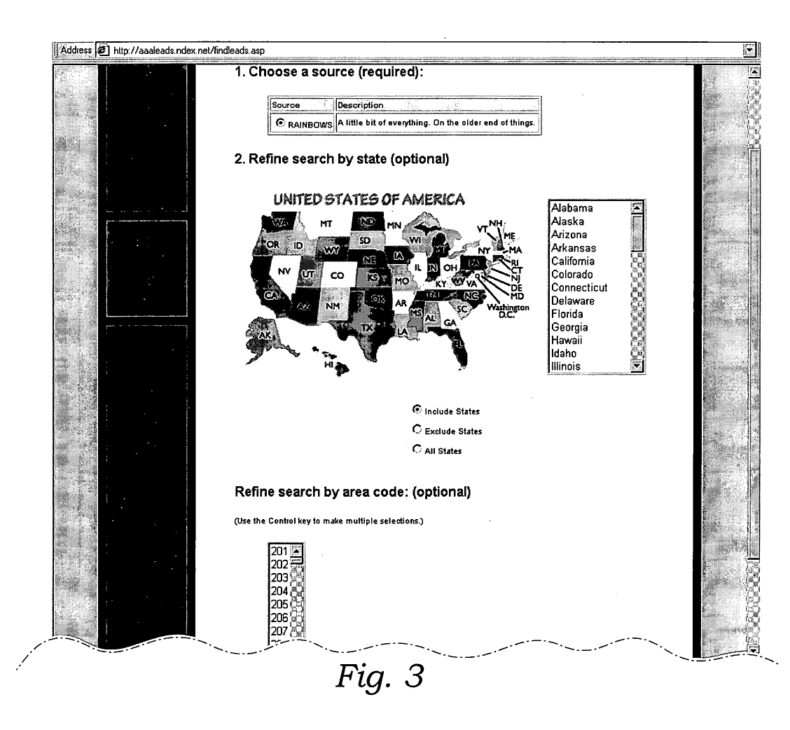

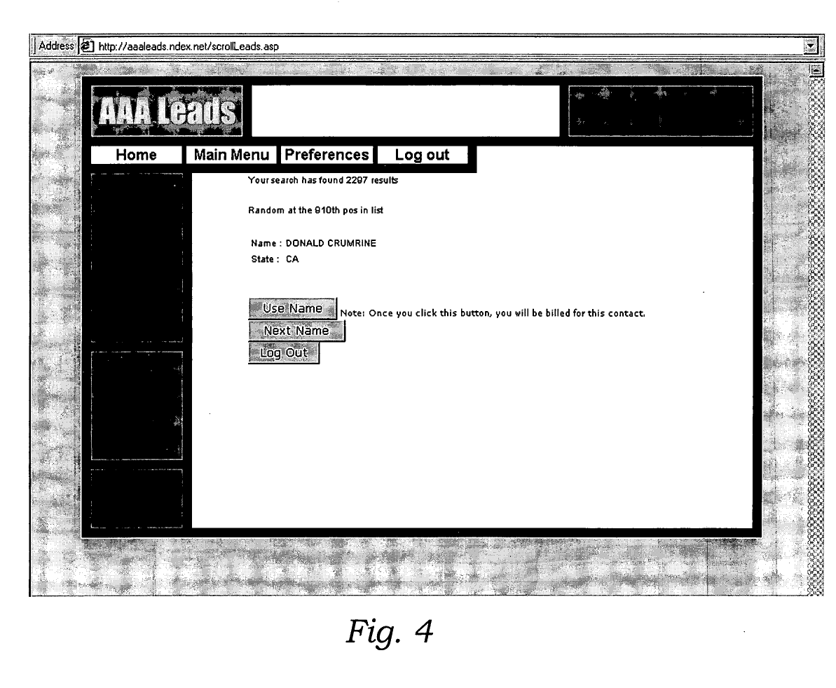

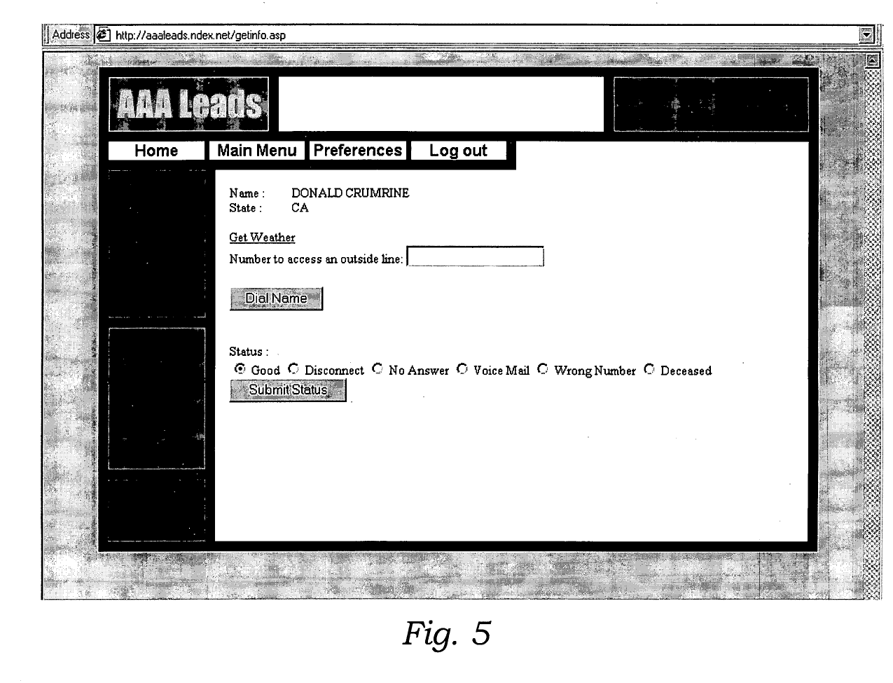

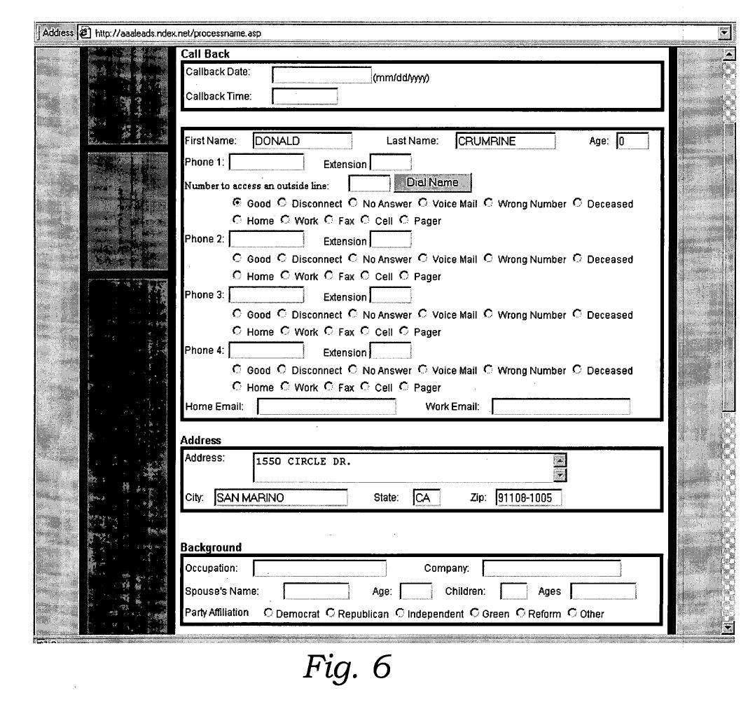

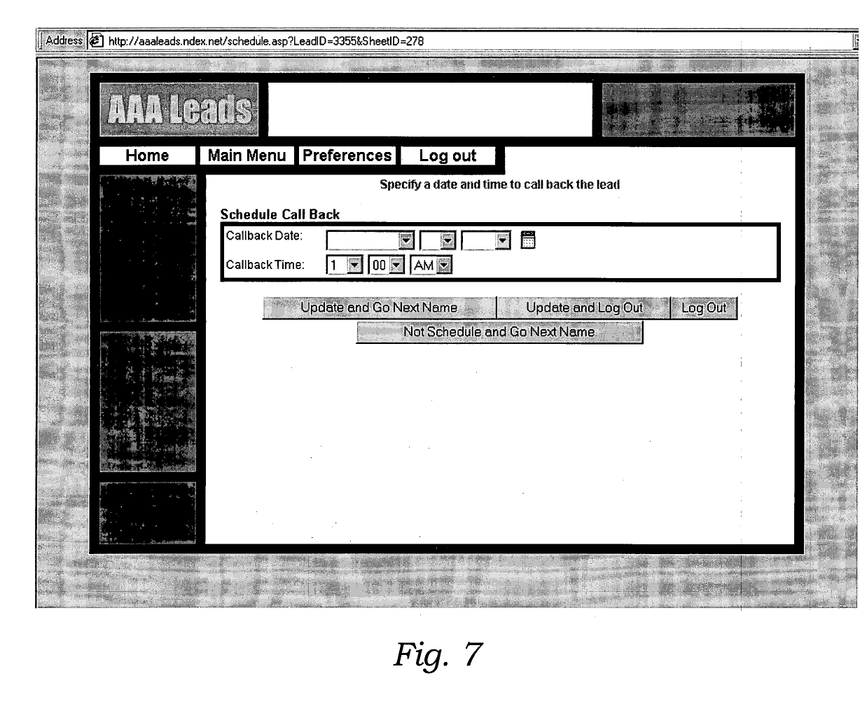

Referring now to FIGS. 2-7, which are screen shots of several of the screens used in the present method, we see in FIG. 2, a welcome screen which appears upon initialization of the present method. Choices may be made by mouse selection, or otherwise, from: Find Leads, Good Dial, Schedule and Preferences. Upon selection of Find Leads, the screen of FIG. 3 appears, from which a source of database information may be selected, including geographical location. This screen is only an example of the types of choices that may be made, and such choices may extend to many other categories including industry (SIC code), phone area code, county, state, city, zip code, etc. Once a database has been selected, as shown in FIG. 4, the size of the database is displayed and the first entry or lead in the database is identified. In this case, Donald Crumrine is the first lead. The user may chose to use the name presented or move to the next name due to ethnic quality of the name, geographical location, male v. female or other issues. In the screen of FIG. 5, we see that the user may chose to dial the lead and this is done automatically, and again, without disclosure of the lead's phone number to the user. A status is selected by the user depending on the outcome of the call. If contact is made with a party that represents the lead, “Good” is selected as shown in FIG. 5. If the call is disconnected, this status may be selected. If there is no answer, the user may select that status. If a message is left on voice mail, the user can identify this status. If the call is to a wrong number, or the party is permanently not available at the number dialed, such status may be selected. In FIG. 6 we see that details of the call may be logged by the user for each lead, including, callback information and lead contact information including background. Moving to the screen of FIG. 7, we see that the user may schedule a reminder to call the lead back at a future date and time.

As defined, the present method enables the user to designate each lead provided by the database as a good or bad contact, i.e., operating and correct phone number to the designated name, or not, and to thus control billing to only the identified good numbers. The service billing will therefore be based on only the good connection results. Call that result in disconnects, no answer, wrong number and permanently not available are not invoiced, while call that result in contact (good), or leaving a voice mail message are counted as billable. All leads in the selected and provided database that are not contacted, are not the subject of invoicing until one of the six status categories (FIG. 5) are determined.

One may at any time revise the selection of the database in accordance with at least one of: a geographical, time zone, standard industrial code, mail zip code, and telephone area code or any other preference. This means that a previously selected database may be cancelled at any time and a new database may be selected, without a billable event taking place. Invoicing is, again, only predicated on Good and Voice Mail status of contacted leads.

In FIG. 1, details of the software instruction set of the preferred embodiment are described. We see that after the user logs on to the service, the user may select to view a new lead database or view a previously used database of leads. If new leads are desired, the user may select from a plurality of databases available by category including location and time zone. The service compiles the database and makes it available to the user's computer. The user may elect to look at leads in the database starting with the first entry in the database, or the last entry, or by random selection. If random selection is selected, a pseudo-random number between the cardinal numbers represented by the first entry and the last entry is generated using the well known RND function. The instruction set identifies leads that have been used and excludes them from the next random selection. This process takes place in box 10 of FIG. 1 on sheet 1 of 8. The randomly selected lead may be used or a next lead may be requested as shown in box 20 of the diagram. On sheet 2 of 8 we see that the phone number for leads is concealed so as to remain unavailable to the user until a status of the lead is determined as defined above. As defined, the user marks the status of the lead and unless the lead is good or voice mail is used, the user is not charged for using the lead. If the lead is good or voice mail used, the phone call is timed and the time and billing status is displayed on the users monitor. As shown, the user can retrieve previously good leads or voice mail leads for call back. The timer permits time management by user for reviewing the amount of time spent talking to each lead and the time duration relationship to closed orders or lead compliance. The timer also thwarts the user from falsely claiming that a lead was not contacted when, in fact, time was logged in discussions with the lead where such time duration may be found to be inconsistent with an non-billable event. All calls are logged so that the service is informed as to the time of day calls were placed and the duration of each said call.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A solicitation method comprising the steps of: providing a lead database to a user, the lead database containing a plurality of leads, each of the leads including an associated lead identity and a concealed lead telephone number; operating a user computer system having an automatic phone dialup feature; dialing at least one of the leads in the database using the concealed lead telephone number without revealing the lead telephone number to the user; selecting a result of dialing the lead telephone number; billing the user for each selected result only when the selected result is beneficial; and revealing the telephone number to the user only when the result is beneficial.

2. The method of claim 1 wherein the step of selecting a result of dialing is completed using a list of selected results including: voice contact made, voice mail left, disconnected, wrong-number, and permanently not available.

3. The method of claim 1 further comprising the step of selecting the lead database from a pool of leads by choosing lead parameters from at least one of: industry, geography, time zone, mail zip code, telephone area code, and demographic parameters.

4. The method of claim 1 further comprising the step of selecting at least one of the leads using a pseudo-random number generator.

5. The method of claim 1 further comprising the step of making the database available to the user via the Internet.

6. The method of claim 1 further comprising the step of presenting action choices to the user; the action choices including at least one of: finding leads, previously connected leads, call back scheduled leads and preferences.

7. The method of claim 3 wherein the step of selecting the lead database includes presentation of a monitor screen having a map, a list of states, and a list of phone system area codes.

8. The method of claim 3 wherein the step of selecting the lead database includes presentation of a monitor screen having a statement of the number of leads in the database.

9. The method of claim 1 further comprising the step of presenting a monitor screen for lead contact information fill-in.

10. The method of claim 1 further comprising the step of presenting a monitor screen for scheduling a time for call-back to a lead.

11. The method of claim 1 further comprising the step of timing telephone calls between user and lead to determine a telephone call contact duration; and informing the user thereof.

12. The method of claim 11 further comprising the step of billing the user when the contact duration exceeds a selected time duration.

13. The method of claim 12 wherein telephone calls are logged so that time of call initiation and call duration is known for monitoring purposes.

14. The method of claim 1 further comprising the step of identifying and logging a lead that should not be contacted by the user.
